(19) United States
(12) Patent Application Publication
(10) Pub. No.: US 2007/0212180 A1
(43) Pub. Date: Sep. 13, 2007

(54) Method and apparatus for converting semiautomatic key cutting machines to automatic operation

(76) Inventor: Mehdi Zahedi, Kettering, OH (US)

Correspondence Address: Mehdi Zahedi, 3116 Allendale Dr., Kettering, OH, 45409, US

(21) Appl. No.: 11/519,407

(22) Filed: Sep. 12, 2006

Related U.S. Application Data
(60) Provisional application No. 60/765,514, filed on Feb. 6, 2006.

(51) Int. Cl. B23C 3/35

(52) U.S. Cl. 409/132; 409/81

(57) ABSTRACT

A semiautomatic key cutting machine is converted to fully automatic operation. The conversion involves sending available electrical signals and power from the existing semiautomatic key cutting machine to a controller in the conversion apparatus. The signals are used by the controller to operate an external motor that is coupled to the crank wheel of the semiautomatic key cutting machine. The apparatus thereby controls the crank wheel leaving the operator to perform other tasks while a key is being cut. The apparatus can be coupled to the crank wheel of any existing semiautomatic key cutting machine without permanent or irreversible modification to the existing key cutting machine.

### BACKGROUND OF THE INVENTION

This invention relates to semiautomatic key cutting machines as may be used by professional locksmiths, specifically to such machines as may have computer control of the cutting functions and manual control of the position of the key holding vise.

Machines for cutting keys automatically have been available for several years. One example is disclosed in U.S. Pat. No. 5,997,224 to Beauregard et al in 1999. These are computer controlled machines in which the locksmith enters relevant data into the machine's computer by means of a computer keypad, clamps a key blank into the machine's vice, and pushes a button to start the machine cutting the desired pattern of notches into the key blank. The operator need not attend the machine while it is cutting a new key, but may attend to other business. Such machines are of considerable utility to professional locksmiths, but are relatively expensive.

Another class of key cutting machines is referred to as semiautomatic key cutting machines. One example of a semiautomatic key cutting machine is described in U.S. Pat. No. 5,711,643 to Parr et al in 1998. These machines possess all the features of the automatic key cutting machines except they require the operator to turn a crank wheel while the key is being cut. Turning the crank wheel causes the vise in which the key blank is held to move laterally while the cutter is automatically moved longitudinally to cut the desired notches in the key blank. The present invention pertains to the modification of this type of machine. Cutting a single key may require the operator to perform from ten to twenty rotations of the crank wheel in each direction thereby causing physical strain to wrist and arm muscles. It is also necessary for the operator to have a certain amount of skill since turning the crank wheel at the wrong speed while cutting a key can damage the expensive cutting wheel. These semiautomatic key cutting machines are less expensive than the fully automatic key cutting machines, but they require complete and continuous operator attention while the new key is being cut. The operator is, therefore not free to perform other tasks. Furthermore, the operator is required to perform a repetitive physical task namely turning the crank wheel. While this task is not physically exhausting, it does require a repetitive physical stress on the arm and wrist that can lead to medical problems such as carpal tunnel syndrome.

Modifications to semiautomatic key cutting machines have been proposed. See, for example U.S. Pat. No. 4,971,489 to Womack, which teaches the addition of a large crank wheel coupled by a belt to the semiautomatic key cutting machine's crank wheel. The added larger crank wheel need be turned fewer times while causing the original crank wheel to rotate many times thus reducing the operator work load. Unfortunately, the operator must still attend the key cutting machine for the duration of a cutting session and cannot use this time to attend other tasks. Operator skill is also required to insure the crank wheel is not turned at an excessive speed causing damage to the cutting wheel.

Accordingly several objects and advantages of my invention are:

(a.) To provide a method and apparatus for automatically positioning the vise of a semiautomatic key cutting machine having a crank wheel. Such automatic positioning of the vise of a semiautomatic key cutting machine frees the operator to perform other tasks while a key is being cut, and reduces physical repetitive stress on the operator's wrist and arm.

(b) To provide a method and apparatus for automatically turning the crank wheel of a semiautomatic key cutting machine at the optimum speed so as to minimize cutting time while simultaneously protecting the expensive cutting wheel from damage.

(c) To provide an easily installed method and apparatus for automatically turning the crank wheel of a semiautomatic key cutting machine thereby obviating the necessity for drilling holes soldering electrical connections or otherwise modifying an existing semiautomatic key cutting machine.

(d) To provide a method and apparatus for automatically turning the crank wheel of a semiautomatic key cutting machine in such a manner that the apparatus can be easily removed after installation, and the semiautomatic key cutting machine can be easily restored to its original unmodified condition.

(e) To provide a method and apparatus for automatically turning the crank wheel of a semi automatic key cutting machine which method and apparatus detects faults and automatically stops turning the crank wheel if a fault is detected.

(f) To provide a method and apparatus for automatically turning the crank wheel of a semiautomatic key cutting machine such that the automatic method and apparatus can be easily over-ridden by the machine's operator. Convenient manual operation of the crank wheel on the semiautomatic key cutting machine is possible even with this invention installed.

(g) To provide a method and apparatus for automatically turning the crank wheel of a semiautomatic key cutting machine which method can be easily altered by changing its software program such that it can be used on a variety of existing semiautomatic key cutting machines and also adapted to future designs of semiautomatic key cutting machines.

(h) To provide an inexpensive method and apparatus for converting a semiautomatic key cutting machine to fully automatic operation thereby obtaining the advantages of fully automatic operation without incurring the expense of a fully automatic key cutting machine.

### SUMMARY OF THE INVENTION

In accordance with the present invention a method and apparatus for automatically positioning the vise of a semiautomatic key cutting machine is provided. Instead of the operator being required to turn the crank wheel of the semiautomatic key cutting machine, the present invention controls the crank wheel thus permitting the operator to perform other tasks during the actual key cutting process. The operator is also freed of the repetitive physical stress caused by manually turning the crank wheel. Because the present invention is electronically controlled by a programmable microcontroller, the invention can be used on a wide variety of existing and future semiautomatic key cutting machines.

### DESCRIPTION OF THE DRAWINGS

In the drawings identical components have the same number.

FIG. 1 is an isometric view of a typical or generic existing semiautomatic key cutting machine without the invention installed.

FIG. 2 is an isometric view of a typical or generic existing semiautomatic key cutting machine with the invention installed and fastened to the existing semiautomatic key cutting machine.

FIG. 3 is an isometric view of a typical or generic existing semiautomatic key cutting machine with the invention installed in such a way that the invention is not fastened to the existing semiautomatic key cutting machine.

FIG. 4 is a block diagram of the electronic elements of a preferred embodiment of the invention.

FIG. 5 is a flow diagram of the program contained in the microcontroller of FIG. 4.

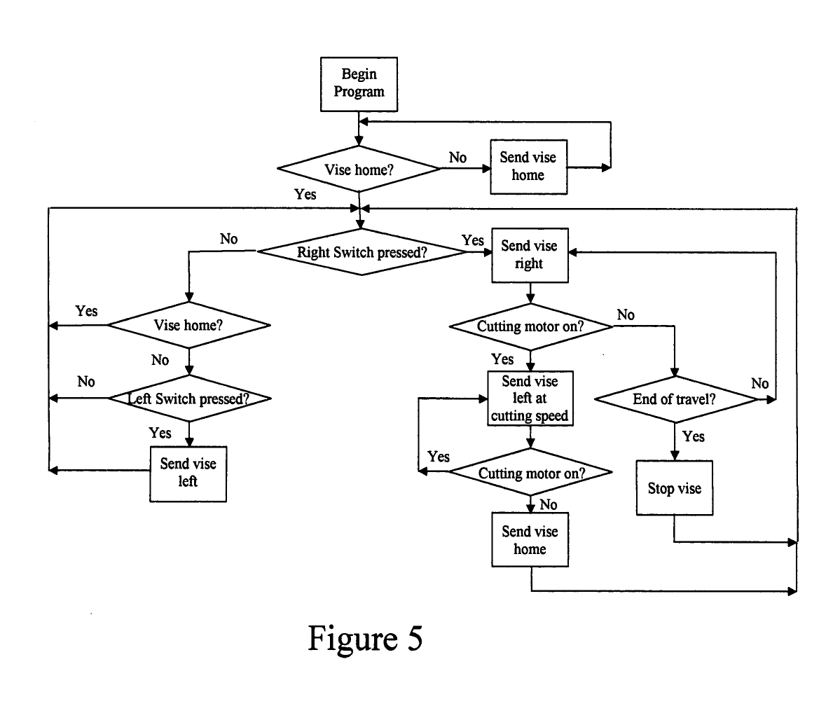

### REFERENCE NUMERALS IN DRAWINGS

1 crank
2 crank wheel
3 cutting wheel motor
4 cutting wheel
5 vise
6 key blank
7 display window
8 keypad
9 crank wheel with provision for accepting drive belt
10 crank
11 drive belt
12 drive wheel
13a attachment member
13b attachment member
14 crank wheel drive motor
15 rotation sensor and drive motor wiring
17 control box
18 pushbutton switch
19 control switch
20 electrical power and control wires
21 rotation sensor
22 mounting plate
23 mounting plate
24 base

### DETAILED DESCRIPTION OF THE INVENTION

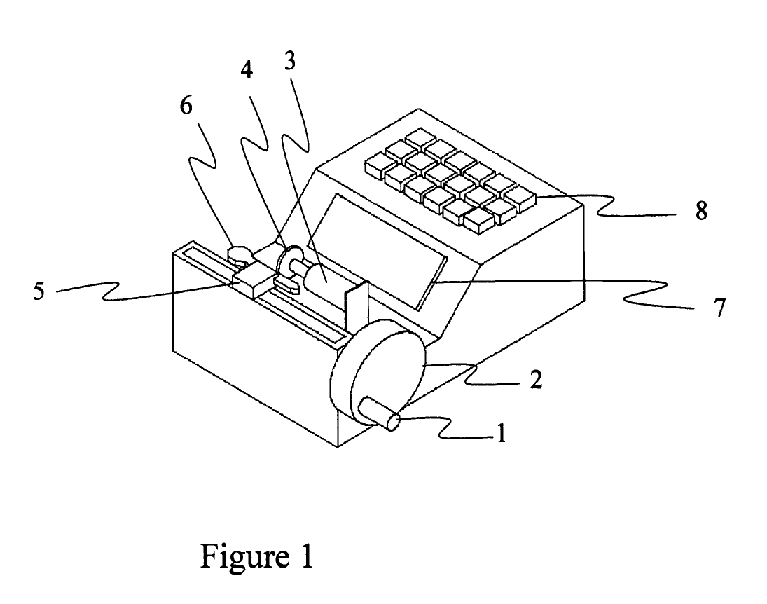

Referring to the drawings, FIG. 1 is a drawing of a semiautomatic key cutting machine before installation of the present invention. To cut a key, the operator applies electrical power to the machine, and follows the directions shown in display window 7. It is often necessary for the operator to turn crank wheel 2 using crank handle 1 to the right and left to position the vise in its starting or “home” position. The operator uses keyboard 8 to enter the appropriate code for the key to be cut. The operator then inserts a suitable blank key 6 into vise 5. After fastening the key in the vice, the operator turns crank wheel 2 using crank handle 1 in accordance with the instructions given in display window 7. Turning crank wheel 2 causes vise 5 to move to the right or left depending on whether the crank wheel is turned clockwise or counterclockwise. When the operator has turned crank wheel 2 the appropriate number of turns in the appropriate direction, cutting motor 3 is automatically turned on by the semiautomatic key cutting machine causing the sharp cutting wheel 4 to rotate. The operator receives instructions in display window 7 to turn the crank wheel such that the vise is moved from right to left. At the same time rotating cutting wheel 4 is automatically pressed against the edge of key blank 6 with the appropriate amount of force to cut the key to the appropriate depth. As crank wheel 2 is turned, vice 5 holding the key blank 6 progresses from right to left, and rotating cutting wheel 4 automatically moves in and out thereby cutting the appropriate number of notches each to the appropriate depth in key blank 6. When cutting is complete, cutting motor 3 is automatically stopped. The operator continues turning crank wheel 2 in the same direction until vise 5 reaches its home position at which time the operator removes completed key 6 from vise 5. The process must be repeated for each key to be cut.

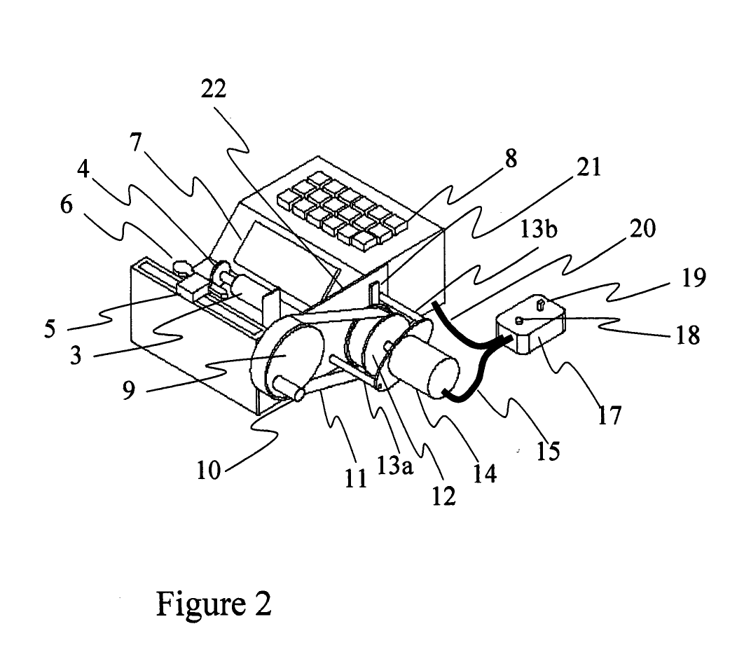

FIG. 2 is an isometric drawing of one possible embodiment of a semiautomatic key cutting machine with the present invention installed. In FIG. 2 the existing semiautomatic key cutting machine is delivered with two holes drilled and tapped for holding sliding members of the existing semiautomatic key cutting machine. These same drilled and tapped holes are used to fasten the present invention to the existing semiautomatic key cutting machine. Elements added or changed by the present invention are crank wheel 9, drive belt 11, drive wheel 12, crank wheel drive motor 14, attachment members 13a and 13b, rotation sensor 21, rotation sensor and drive motor wiring 15, control box 17, pushbutton switch 18, control switch 19, electrical power and control wires 20, and mounting plate 22. To install the present invention the original crank wheel (2 in FIG. 1) is removed from the semiautomatic key cutting machine. The mounting plate holding the attachment members 13a and 13b, the motor 14, drive wheel 12, and rotation sensor 21 is fastened to the semiautomatic key cutting machine by means of the existing drilled and tapped mounting holes. New crank wheel 9, which is part of the present invention, and timing belt 11 are installed. Electrical power and control wires 20 are connected to existing appropriate connectors on the existing semiautomatic key cutting machine so as to provide appropriate electrical power and control signals. Control box 17 holds the control electronics and any necessary computer program and memory for the control electronics.

To cut a key with the present invention installed the operator applies electrical power to the semiautomatic key cutting machine, and follows the directions shown in display window 7. He/she uses keyboard 8 to enter the code appropriate for the key to be cut. He/she then inserts a suitable key blank 6 into vise 5, which firmly holds the blank. The operator then pushes control switch 19 to the right momentarily and releases it. The control electronics automatically causes motor 14 to move the vise 5 to the right until cutting motor 3 starts. The existing semiautomatic key cutting machine sends through wiring 20 an electrical signal to the control electronics indicating the cutting motor is running. The control electronics commands motor 14 to move vise 5 at the correct speed to the left so that key blank 6 can be cut by cutting wheel 4. When the key cutting operation is complete, cutting motor 3 is turned off by the semiautomatic key cutting machine which also sends an electrical signal to the control electronics indicating the cutting motor has been stopped. The control electronics then commands motor 14 to increase its speed and return vise 5 to its far left or “home” position in preparation for cutting another key.

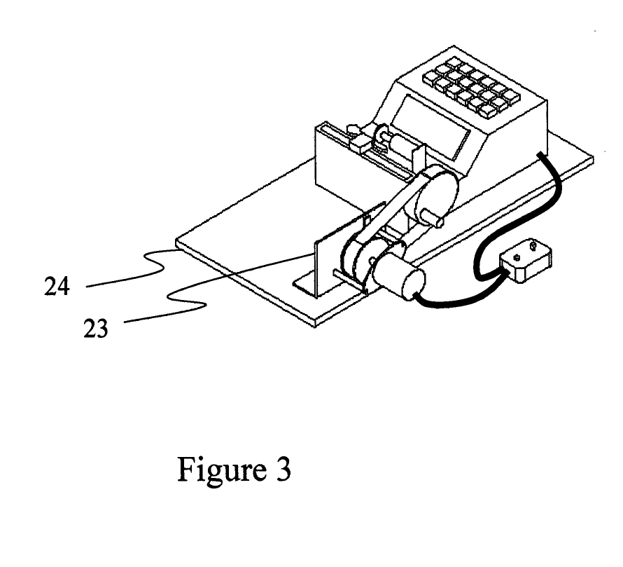

Another embodiment of the invention, which allows operation of the invention without affecting the form of the existing semiautomatic key cutting machine is shown in FIG. 3. The present invention is shown fixed by means of mounting plate 23 to a base 24 on which the existing semiautomatic key cutting machine is also placed. The existing semiautomatic key cutting machine is placed on the base such that the drive belt couples the drive wheel of the invention to the crank wheel of the existing semiautomatic key cutting machine.

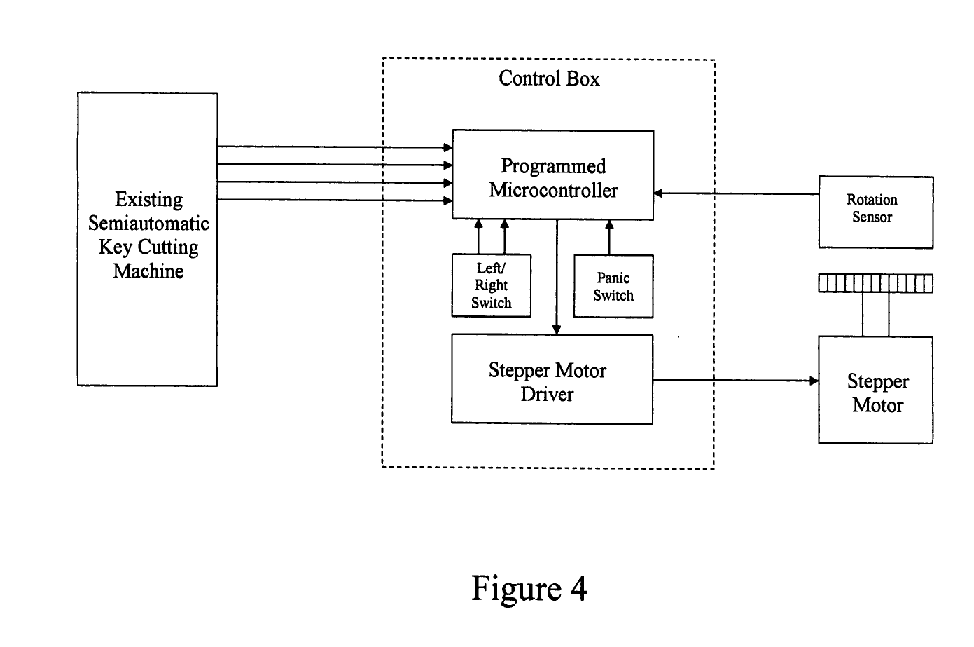

FIG. 4 is a block diagram showing a preferred embodiment the electronic components of the invention. In this preferred embodiment the control box contains a Programmed Microcontroller, a Stepper Motor Driver, a spring loaded single pole double throw center off switch labeled the Left/Right Switch, and a single pole single throw normally off spring return pushbutton switch labeled the Panic Switch. A Rotation Sensor consisting of a reflective optical-interrupter is fastened to the mounting plate. The Rotation Sensor beams an infrared light toward the drive wheel attached to the Stepper Motor and uses the reflected infrared light to determine whether or not the drive wheel attached to the Stepper Motor is rotating. The Programmed Microcontroller accepts electrical power and electrical signals from the Existing Semiautomatic Key Cutting Machine, signals from the Left/Right and Panic Switches and a signal from the Rotation Sensor. The Programmed Microcontroller sends the appropriate signals to the Stepper Motor Driver to cause the Stepper Motor to rotate in the appropriate direction and at the appropriate speed. The Stepper Motor is coupled by means of a drive belt to the crank wheel attached to the Existing Semiautomatic Key Cutting Machine. Rotation of the Stepper Motor therefore causes the crank wheel to turn, which in turn causes the vise to move either to the left or to the right.

When electrical power is applied to the Existing Semiautomatic Key Cutting Machine electrical power is also applied to the control box electronics. The Programmed Microcontroller receives a vise position signal from the Existing Semiautomatic Key Cutting Machine. The Programmed Microcontroller sends a signal to the Stepper Motor Driver causing the stepper motor to turn in the appropriate directions so as to move the vise slightly to the right and then slightly to the left such that the vise reaches its home position. The Stepper Motor is then stopped. After the operator inserts a blank key into the vise and enters the appropriate commands via the keypad into the Existing Semiautomatic Key Cutting Machine, he/she momentarily moves the Left/Right Switch to the Right to start the key cutting process. The Programmed Microcontroller senses the movement of the Left/Right Switch and sends a signal to the Stepper Motor Driver causing the Stepper Motor to rotate thus moving the vise to the right. When the vise reaches the proper position, as determined by sensors in the Existing Semiautomatic Key Cutting Machine power is applied to the cutting motor causing the cutting wheel to spin. The Existing Semiautomatic Key Cutting Machine sends an electrical signal to the Programmed Microcontroller indicating the cutting motor is running. The Programmed Microcontroller sends a signal to the Stepper Motor Driver, which causes the Stepper Motor to rotate in the appropriate direction so as to cause the vise to move to the left, and the cutting wheel begins cutting the key. The Programmed Microcontroller continues to cause the vise to move to the left at the programmed optimum speed for key cutting until the key is fully cut. When the key is fully cut the Existing Semiautomatic Key Cutting Machine turns off the cutting motor and sends an electrical signal to the Programmed Microcontroller indicating the cutting motor is no longer running. The Programmed Microcontroller then sends a signal to the Stepper Motor Driver causing the stepper motor to rotate at a higher speed so as to return the vise quickly to its home position. When the vise reaches its home position, the Existing Semiautomatic Key Cutting Machine sends a signal to the Programmed Microcontroller, which causes the Stepper Motor to stop rotating.

If a key is not being cut and the operator wants to move the vise to the right he/she momentarily pushes the Left/Right Switch to the Right and releases it. The programmed Microprocessor sends commands to the Stepper Motor Driver causing the Stepper Motor to move the vise to the right. If the vise reaches its extreme rightmost position the drive wheel stops rotating, the rotation sensor reports this condition to the Programmed Microprocessor, and the Programmed Microprocessor sends a signal to the Stepper Motor Driver removing power from the Stepper Motor causing the Stepper Motor, and hence the vise to stop.

Similarly if the operator momentarily moves the Left/Right Switch to the Left and releases it the Programmed Microcontroller sends a signal to the Stepper Motor Driver causing the Stepper Motor rotate moving the vise to the Left. If the vise reaches its Leftmost or “home” position the Existing Semiautomatic Key Cutting Machine sends a signal to the Programmed Microcontroller indicating the vise is at its home position. The Programmed Microcontroller sends a signal to the Stepper Motor Driver causing the Stepper Motor to stop.

If at any time the operator pushes the Panic Button, the Programmed Microcontroller sends a signal to the Stepper Motor Driver causing the Stepper Motor to stop.

I claim:

1. A method of converting an existing semiautomatic key cutting machine to automatic operation said existing semiautomatic key cutting machine having a manually operated crank wheel to control the lateral position of the key holding vise; said method comprising:
accepting power and control signals from said existing semiautomatic key cutting machine; and
providing power and control signals to an external motor; and
coupling said external motor to said manually operated crank wheel.

2. The method of claim 1 wherein a timing belt is employed to couple said external motor to said manually operated crank wheel.

3. The method of claim 1 wherein said power and control signals are provided by one or more programmable microcontrollers.

4. The method of claim 1 wherein said conversion is accomplished without causing any permanent or irreversible change to said existing automatic key cutting machine.

5. The method of claim 1 wherein said existing semiautomatic key cutting machine can be manually operated even with said conversion method and apparatus installed.
